(19) United States
(12) Patent Application Publication
(10) Pub. No.: US 2022/0363181 A1
(43) Pub. Date: Nov. 17, 2022

(54) MECHANISM FOR LOADING AND UNLOADING MATERIALS, FOR A CONTAINER

(71) Applicants: COMERCIAL NUTRESA SAS, Medellin (CO); PONTIFICIA UNIVERSIDAD JAVERIANA, Bogotá (CO)

(72) Inventors: Oscar BERNAL NISPERUZA, Bogotá (CO); Jorge Enrique CORDOBA SANCHEZ, Bogotá (CO); Daniel Francisco HOYOS CAVIEDES, Bogotá (CO); Jairo Alberto LONDOÑO ZAPATA, Medellín (CO); Héctor NAVARRO LÓPEZ, Medellín (CO); Sandra Marcela PEÑUELA MARÍN, Bogotá (CO); Leonardo Augusto QUINTANA JIMENEZ, Bogotá (CO); Christian Ricardo ZEA FORERO, (CO)

(21) Appl. No.: 17/765,571

(22) PCT Filed: Oct. 1, 2020
(86) PCT No.: PCT/IB2020/059225

§ 371 Date: Mar. 31, 2022

(30) Foreign Application Priority Data
Oct. 1, 2019 (CO) NC2019/0010919

(51) Int. Cl. B60P 1/02; B60P 1/52; B62D 33/04

(52) U.S. Cl. CPC B60P 1/02; B60P 1/52; B62D 33/04

(57) ABSTRACT

This invention corresponds to a mechanism for loading and unloading materials for a container, comprising at least one guide located inside the container; at least one rigid panel connected by means of a first sliding element to the side guide, where said side guide allows the displacement of the rigid panel along a first direction. Furthermore, the mechanism of this invention includes a loading panel connected to the rigid panel, said loading panel being arranged parallel to a floor of the container.

### FIELD OF THE INVENTION

This invention relates to mechanisms for loading and unloading materials for a container. Particularly, this invention relates to loading and unloading mechanisms for improving the ergonomics and efficiency of an operation.

### DESCRIPTION OF THE PRIOR ART

In the different productive sectors worldwide, there is a myriad of tasks manually carried out, which have been widely noticed in the industry. These tasks are typically done without mechanical aids, among which are lifting, lowering, or pushing a load, e.g., there are manual activities in the food sector, performed in goods delivery vehicles. These types of activities have been identified as potentially hazardous in the development of musculoskeletal disorders due to cumulative trauma. Therefore, it is necessary from the field of ergonomics the constant search for improvements to reduce the probability of developing musculoskeletal injuries in operators, also considering the productivity improvement in operations.

Specifically, musculoskeletal disorders (MSDs) have been recognized as the main cause of incapacity and absenteeism, both internationally and locally in Colombia, which generates significant increases in the internal costs of companies. For example, in Colombia since 2001, diseases associated with MSDs went from taking up 65% of all diagnoses to 90% in 2012. Moreover, in that same year, 85% of occupational diseases were concentrated in workers between 28 and 57 years of age (Executive Report II National Survey of Occupational Safety and Health Conditions in the General Risk System, 2013).

For example, one of the most recurrent MSDs in the population, considered in some countries as a public health problem, is low back pain. The causes of this pathology are diverse; however, it has been noticed that manual load handling activities are associated with this pathology. In particular, there is the effort made by the trunk muscles to keep the spine stable in demanding tasks that increase intradiscal pressures. Moreover, the risk also increases due to the magnitude of the load, the posture and frequency of lifting, and the previous history of low back pain. Therefore, exposure to vibration and manual lifting may trigger pathologies such as low back pain.

On the other hand, the times that manual activities can take in loading and unloading operations are quite variable, due among other reasons to the fact that materials (e.g., boxes) may vary in size and weight, which causes operators to vary the loading and unloading times of different shipments of materials. Therefore, loading and unloading operations cannot be correctly standardized and, in some cases, these operations are the bottleneck in some supply processes as they are delayed.

Considering the foregoing, there is a need to find solutions allowing proper handling of materials to avoid diseases and, at the same time, improving the efficiency of the loading and unloading operation.

On the other hand, in the prior art, documents US20170158107A1, U.S. Pat. No. 9,073,470B2 and US20040086367A1 are identified, which relate to mechanisms for loading and unloading materials.

On the other hand, US20170158107A1 discloses a transport system for loading a trailer comprising a support frame adapted to be coupled to the floor of a trailer, a transport mechanism coupled to the support frame and configured to extend at least a portion of a length extending from a trailer rear to a trailer front; and a conveyor rail arranged to extend between the support frame and the transport mechanism, and interconnect therewith.

Further, US20170158107A1 comprises at least one load platform panel configured to connect articulately to a trailer wall. Accordingly, the platform panel may have a closed position, in which the platform panel is placed adjacent to the wall, and an open position, in which the platform panel is placed adjacent to the conveyor rail.

However, document US20170158107A1 discloses that there is a conveyor rail to move the materials to the bottom of the trailer, and loading platforms are used to hold the material. The foregoing generates waste of space in the trailer because there are different elements inside the trailer to perform several functions, such as moving the materials to the bottom of the trailer and holding the materials.

On the other hand, document U.S. Pat. No. 9,073,470B2 discloses a delivery vehicle comprising a bay having two parallel rectangular frames, each frame having two horizontal members and two vertical members, and a movable clamping structure connected to the rectangular frames at their vertical members. The clamping structure comprises a first horizontal frame adjacent to each of the vertical members of the two rectangular frames and a first motor.

U.S. Pat. No. 9,073,470B2 also discloses a first belt positioned between the lower horizontal members of the two rectangular frames and below the first horizontal frame. The first belt is configured to allow lateral movement in the first direction along a first opening, which extends in the first direction of the first horizontal frame and within the confines of the two rectangular frames. The operation of the first motor provides vertical movement of the holding structure within the confines of the two rectangular frames.

However, U.S. Pat. No. 9,073,470B2 discloses that the holding structure supporting the materials moves vertically, by means of a first motor, and a first belt allows movement across the width of the delivery vehicle. Further, U.S. Pat. No. 9,073,470B2 discloses that the holding structure is arranged horizontally between the two rectangular frames forming the bay, the foregoing preventing access to the bottom of the bay because the holding structure takes up the entire space between the horizontal frames. Also, this document discloses that the holding structure takes up the entire space between the horizontal frames, making it necessary to use several belts to move the entire bay space.

On the other hand, document US20040086367A1 discloses a structural frame supporting a movable mounting bracket, comprising a motion guidance system with at least one guide column secured to the structural frame and a carriage that is movable along the guide column and secured to the structural frame. The motion guidance system includes an anti-rotation bearing bracket attached to the movable carriage and movably secured to the structure; and a support device connected to the structure, and a bracket for controlling the bracket position with respect to the structural frame.

However, US20040086367A1 discloses that the support device holding the material moves vertically by means of the movable carriage. The support device is limited to vertical movement, since US20040086367A1 discloses that the structural frame can be moved by means of wheels, for another type of movement.

Therefore, the prior art discloses different mechanisms allowing to move loads within a container. However, such documents do not take advantage of the entire space in the material container, either because they take up all of it with a single element or because they use multiple elements within the container to carry out functions, which may be complementary.

### BRIEF DESCRIPTION OF THE INVENTION

This invention corresponds to a mechanism for loading and unloading materials for a container, comprising at least one guide located inside the container; at least one first rigid panel connected by means of a first sliding element to the guide, where said at least one guide allows displacement of the first rigid panel along a first direction; and a first loading panel connected to the first rigid panel, where said first loading panel is arranged parallel to a floor of the container.

### BRIEF DESCRIPTION OF THE FIGURES

FIG. 1A shows one embodiment of a loading and unloading mechanism comprising a container, a side guide, a rigid panel, and a loading panel, wherein the rigid panel is in a first longitudinal position.

FIG. 1B shows an embodiment of a loading and unloading mechanism comprising a container, a guide, a first rigid panel and a first loading panel with a stop, wherein the first rigid panel is in a second longitudinal position.

FIG. 2A shows one embodiment of a loading and unloading mechanism comprising a container, a side guide, a first rigid panel, a pivot element and a first loading panel with a stop, wherein the first loading panel is in a first position perpendicular to the floor of the container.

FIG. 2B shows one embodiment of a loading and unloading mechanism comprising a container, a side guide, a rigid panel, and a loading panel, wherein the first loading panel is in a second parallel position to the floor of the container.

FIG. 3 shows one embodiment of a rigid panel, a pivot element, and a loading panel, wherein the pivot element is a hinge.

FIG. 4 shows one embodiment of a rigid panel, a pivot element, a loading panel, some rolling elements, and a locking mechanism.

FIG. 5 shows an exploded view of one embodiment of a rigid panel, a pivot element, a loading panel, some rolling elements, and a locking mechanism.

FIG. 6 shows a view of transversely arranged upper guides and longitudinally arranged upper guides before being assembled to the container, wherein said upper guides are orthogonal to each other. Additionally, a view with the upper guides arranged on a ceiling of the container is shown, wherein the upper guides are rails.

FIG. 7A shows one embodiment of a loading and unloading mechanism comprising a container, transversely arranged upper guides and longitudinally arranged upper guides, a rigid panel, and a loading panel, wherein the rigid panel is in a first transverse position, in said position the rigid panel is lying on one of the inner walls of the container.

FIG. 7B shows one embodiment of a loading and unloading mechanism comprising a container, transversely arranged upper guides and longitudinally arranged upper guides, a rigid panel, and a loading panel, wherein the rigid panel is in a second transverse position, in said second transverse position the rigid panel is located in the center of the container.

FIG. 8A shows one embodiment of a loading and unloading mechanism comprising a container, a side guide, an upper guide, a rigid panel, and a loading panel, wherein in the rigid panel is in a second transverse position, in said second transverse position the rigid panel is located in the center of the container.

FIG. 8B shows one embodiment of a loading and unloading mechanism comprising a container, a side guide, an upper guide, a rigid panel, and a loading panel, wherein the rigid panel is in a third longitudinal position, in said position the rigid panel is lying against a back wall of the container.

FIG. 9 shows a vertical displacement mechanism connected to a second group of rolling elements, said second group of elements is arranged on a floor of a container, wherein the vertical displacement mechanism comprises a bar, a coupling element, and a lever. Additionally, the positions of the second group of elements are shown, wherein they protrude above the floor (dotted line) in one position and, in another position, they are located below the floor.

FIG. 10 shows a pre-assembly exploded view of a connecting element, connected to a first rigid panel with a first loading panel, and a second rigid panel with a second loading panel.

FIG. 11 shows the assembly between a connecting element, a first rigid panel with a first loading panel and a second rigid panel with a second loading panel.

FIG. 12 shows an embodiment of a loading and unloading mechanism comprising a container, two side guides, transversely arranged upper guides, longitudinally arranged upper guides, a first rigid panel, a second rigid panel, a first loading panel, a second loading panel and first rolling elements.

FIG. 13 shows an undeployed lifting mechanism connected to a platform, said lifting mechanism being located on a ceiling of the container. Additionally, an access ladder, a side access ladder and a side access door are shown.

FIG. 14 shows a cross section of one embodiment of the container showing a deployed lifting mechanism connected to a platform. Additionally, an access ladder, an access side ladder and an access side door are shown.

FIG. 15A shows a detail view of one embodiment of an access ladder located on a container floor, wherein an additional extension step is connected to the access ladder by a pivot element. In this view, the additional step is deployed and works as an additional step of the access ladder.

FIG. 15B shows a detail view of one embodiment of an access ladder located on a container floor, wherein an additional step is connected to the access ladder by a pivot element. In this view, it is noticed that the additional step is folded and covers the hole left on the floor by the access ladder.

FIG. 16 shows an isometric view of one embodiment of a container with a compartment located in a side wall of the container. Additionally, a side access ladder and a side access door are shown.

FIG. 17 shows a side view of one embodiment of a container connected to a vehicle chassis, wherein a leveling mechanism is connected to the container.

### DETAILED DESCRIPTION OF THE INVENTION

This development relates to a mechanism for loading and unloading materials for a container (1), wherein the container (1) is used to house materials and/or transport them from one location to another, and wherein the loading and unloading mechanism enables the operator to do a faster and safer job compared to the job he/she would do loading and unloading objects using his/her arms.

In order to achieve the foregoing, the mechanism comprises at least one guide located inside the container (1), said guide is connected to at least one first rigid panel (2), which in turn is connected to at least one first loading panel (5). On the other hand, said at least one guide allows the first rigid panel (2) and consequently the first loading panel (5) to move along a direction, being a longitudinal and/or transverse direction.

One of the technical effects of the lengthwise movement of the first rigid panel (2) and consequently the first loading panel (5) is to allow faster loading and unloading of materials compared to the work that would be carried out by loading and unloading objects using the arms, because it prevents an operator from going to the end of the container (1) to place a material, or from pushing the material to the bottom of the container (1). On the other hand, this improves the ergonomics of the operator during the loading and unloading work, by preventing the operator from making efforts to lift or push a material, thus avoiding possible musculoskeletal disorders, such as low back pain.

In this invention, container means any space, enclosure or container used to house materials of any kind, e.g., shipping containers, warehouses, vans, among others.

The container (1) may be designed to be fixed in place, or to be a container (1) for transporting materials. Also, the container (1) may be designed to create a safe environment for the material to be housed, e.g., with a cooling system.

In a particular example, when the container (1) is designed to transport materials, the container (1) may be positioned on the chassis of a vehicle selected from the group including two-axle trucks, three-axle trucks, vans, pickup trucks, tractor-trailers, automobiles, boats, motorboats, ships, helicopters, airplanes, motorcars, motor freighters, and three-wheeled vehicles. Preferably, the vehicle is selected from among two-axle trucks, three-axle trucks, vans, and pickup trucks.

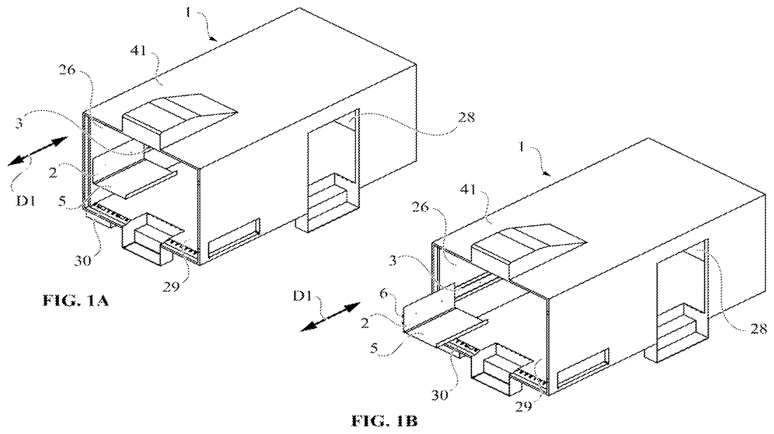

Optionally, referring to FIG. 1A, 1B, 2A, 2B, 6, the container (1) comprises two side walls, a back wall (28), a ceiling (41), a floor (29) and a main entrance (30), at said main entrance (30) an insulation system (31) is arranged. The insulation system (31) can be selected from the group consisting of a hinged door, two hinged doors, a sliding door, two sliding doors, a folding door, two folding doors, roll-up doors, among other equivalent insulation systems known to a person normally versed in the art and combinations thereof.

Regarding the side walls, each side wall has an outer surface and an inner surface, whereby it shall be understood that the first inner side wall (26) is the inner surface of one side wall, and the second inner side wall (27) is the inner surface of the other side wall. For the understanding of this invention, a longitudinal direction is defined as the direction in either way along the container length (1), between the main entrance (30) and the back wall (28). On the other hand, a transverse direction is defined as the direction in either way across the container width (1), between the internal side walls (26, 27).

On the other hand, the material of the container (1) can be selected from the group consisting of wood (e.g., softwoods such as pine, oak and walnut, hardwood, fir, larch, spruce, bamboo, other structurally suitable woods known to a person skilled in the art), steel v.gr (carbon steel, iron castings, galvanized iron, chromium steels, chromium-nickel steels, chromium-nickel-titanium steels, nickel-chromium-molybdenum-tungsten alloy, chromium-molybdenum ferrous alloys, 301 stainless steel, 302 stainless steel, 304 stainless steel, 316 stainless steel, 405 stainless steel, 410 stainless steel, 430 stainless steel, 442 stainless steel, manganese-steel alloy, among others), aluminum, reinforced plastic (e.g., polymethylmethacrylate (PMMA)), polyvinyl chloride (PVC); chlorinated polyvinyl chloride (CPVC); polyethylene terephthalate (PET), polyamides (PA) (e.g., PA12, PA6, PA66); polychlorotrifluoroethylene (PCTFE); polyvinylidene fluoride (PVDF); polytetrafluoride ethylene (PTFE); ethylene-chlorotrifluoroethylene (ECTFE); polymers (polyester, vinyl ester, epoxy resins) reinforced with fibers (e.g., glass, aramid, glass fibers); ceramics (e.g., concrete, metal reinforced concrete), or other equivalent container construction materials known to a person skilled in the art and combinations thereof.

Preferably, the material of the container (1) is selected among steel, aluminum, and polymers (polyester, vinyl ester, epoxy resins) reinforced with fibers (e.g., glass, aramid, polyester). Steel and aluminum are used in these applications, since the former has excellent mechanical features such as rigidity, machinability, and formability, while the latter is environmentally friendly and recyclable. In the case of polymers, such as polystyrene, the selection of these types of materials is because they have a high mechanical resistance or similar to steel or aluminum, they are light, dust resistant, corrosion resistant and easy to clean. Particularly, in case the material to be loaded in the container is food, the material to be selected must be certified for aseptic and food transport environments.

In some cases, the floor (29) of the container (1) may be of different material than the side walls and ceiling (41). This is because the materials to be loaded may have special features, so special materials may be required. For example, the floor (29) can be made of aluminum, wood, or bamboo. In the case of wood, it is selected in containers since it has the capacity to absorb and release moisture. The floor (29) may have an anti-slip surface treatment. For example, the floor (29) may have a surface finish with an average roughness (Rz) greater than 20, which means there is a low slipping probability.

Moreover, the floor material (29) may have a surface finish selected from high relief or low relief finishes, polymeric coatings, grids, tiles, among others.

On the other hand, the guide of the material loading and unloading mechanism is in charge of allowing the displacement along the container (1). This may be at least one side guide (3). The at least one side guide (3) may be arranged on one of the inner side walls (26, 27) of the container (1). The position of the at least one side guide (3) on any one of the inner side walls (26, 27) of the container (1) depends on the type of material to be unloaded and loaded. For example, the at least one side guide (3) may be arranged approximately in the middle of the inner side wall (26, 27) of the container (1) being at a suitable height, to prevent the operator from bending his back to bend down and pick up a material (e.g., a box) and prevent the transported material from falling and hurting the operator. Optionally, the at least one side guide (3) is arranged on the back wall (28), which allows the use of all the container walls (1) and provides a further movement for the materials being unloaded.

Referring to FIGS. 1A and 1B, the loading and unloading mechanism includes a side guide (3) located on the first inner side wall (26) of the container (1) and a first rigid panel connected by means of a first sliding element (6) to the side guide (3), wherein the side guide (3) allows the displacement of the first rigid panel (2) along a first longitudinal direction (D1). Additionally, the loading and unloading mechanism has a first loading panel (5) connected to the first rigid panel (2), said first loading panel (5) being arranged parallel to the floor (29) of the container (1). As shown in FIG. 1B, the first rigid panel (2) can be moved beyond the main entrance (30) along the first direction (D1), which prevents having to enter the container (1) to load or unload the material.

For example, referring to FIGS. 1A and 1B, it is noticed that the first rigid panel (2) is first located in a first longitudinal position, located in the vicinity of the main entrance (30) and, then, in a second longitudinal position wherein it has been displaced towards the back wall (28) of the container (1) in the first longitudinal direction (D1). Accordingly, the first sliding element (6) allows the displacement of the first rigid panel (2) along the first longitudinal direction (D1), which preferably is parallel to the container (1) length.

The first rigid panel (2), which is operatively connected to the side guide (3), is also used as a support for the first loading panel (5). The connection between the first rigid panel (2) and the first loading panel (5) can be made by means of fastening elements, which can be selected from the group consisting of rivets, welding, screws, bolts, pins, cramps, cotter pins, etc. The type of fastening element selected must be adequate to support the load transmitted by the first loading panel (5) once it is supporting some material.

Optionally, the first rigid panel (2) is a frame consisting of two beams and two columns, wherein the first sliding elements (6) are arranged on the columns of the frame, wherein this configuration allows material savings. On the other hand, the first rigid panel (2) is connected to a frame consisting of two beams and two columns, said panel is connected to the frame by means of fastening elements, which allows the first rigid panels (2) to be interchanged when necessary.

In one embodiment of the invention, the first rigid panel (2) and the first loading panel (5) form a monolithic body, e.g., the first rigid panel (2) and the first loading panel (5) may be a steel sheet with a 90° fold. This reduces the time and cost of manufacturing the first rigid panel (2) and the first loading panel (5).

The material of the rigid panels (2) can be selected from the group consisting of steels (e.g., carbon steel, cast iron, galvanized iron, chromium steels, chromium-nickel steels, chromium-nickel-titanium steels, nickel-chromium-molybdenum-tungsten alloy, chromium-molybdenum ferrous alloys, 301 stainless steel, 302 stainless steel, 304 stainless steel, 316 stainless steel, 405 stainless steel, 410 stainless steel, 430 stainless steel, 442 stainless steel, manganese-steel alloy, etc.), aluminum, plastics (e.g., polymethylmethacrylate (PMMA)), polyvinyl chloride (PVC); chlorinated polyvinyl chloride (CPVC); polyethylene terephthalate (PET), polyamides (PA) (e.g., PA12, PA6, PA66); polychlorotrifluoroethylene (PCTFE); polyvinylidene fluoride (PVDF); polytetrafluoride ethylene (PTFE); ethylene-chlorotrifluoroethylene (ECTFE), ceramics (e.g., concrete, reinforced concrete with metal reinforcement), wood (e.g., conifers such as pine, oak and walnut, hardwood, fir, larch, spruce, other structurally suitable woods known to a person skilled in the art), polymers (e.g., polyester, vinyl ester, epoxy, vinyl resins), reinforced with fibers (e.g., polyester, glass, aramid, carbon), other structurally suitable materials known to a person skilled in the art, or combinations thereof.

Preferably, the rigid panels (2) are made of a 1060 aluminum alloy, as they have high corrosion resistance, mechanical and tensile strength.

On one hand, the first loading panel (5) which is connected to the first rigid panel (2), is used to support the weight of the material being loaded, unloaded and/or transported, whereby, said first loading panel (5) may be designed depending on the weight of the material to be treated. As mentioned above, the first loading panel (5) may be connected to the first rigid panel (2) by means of a fastening element. In this case the first loading panel (5) will only be in a parallel position to the floor (29) of the container (1), as seen in FIGS. 1A and 1B, wherein the first loading panel (5) is parallel with respect to the floor (29).

On the other hand, the first loading panel (5) can be hinged and connected to the first rigid panel (2) by means of a first pivot element (8). The pivot element (8) allows the panel to change its angle of inclination with respect to an inner side wall of the container (1) in a range from 0° to 180°.

Now, in a particular example, the first pivot element (8) allows the first loading panel (5) to be arranged in a first position perpendicular to the floor (29) of the container (1) and in a second parallel position to the floor (29) of the container (1). One of the technical effects offered by the first hinged loading panel (5) is that, when it is perpendicular to the floor (29) and supported by the first rigid panel (2), the space inside the container (1) is optimized. This happens when the container (1) is not loaded.

On the other hand, the material of the loading panels (5) can be selected from the group consisting of steels (e.g., carbon steel, iron castings, galvanized iron, chromium steels, chromium-nickel steels, chromium-nickel-titanium steels, nickel-chromium-molybdenum-tungsten alloy, chromium-molybdenum ferrous alloys, 301 stainless steel, 302 stainless steel, 304 stainless steel, 316 stainless steel, 405 stainless steel, 410 stainless steel, 430 stainless steel, 442 stainless steel, manganese-steel alloy, among others), aluminum, plastics (e.g., polymethylmethacrylate (PMMA), polyvinyl chloride (PVC); chlorinated polyvinyl chloride (CPVC); polyethylene terephthalate (PET), polyamides (PA) (e.g., glass, aramid, polyester), ceramics (e.g., concrete, reinforced concrete with metal reinforcement); woods (e.g., conifers such as pine, oak and walnut, hardwood, fir, larch, spruce, other structurally suitable woods known to a person skilled in the art), polymers (e.g., polyester, vinyl ester, epoxy, vinyl resins) reinforced with fibers (e.g., polyester, glass, aramid, carbon), other structurally suitable materials known to a person skilled in the art, or combinations thereof.

Preferably, the loading panels (5) are made of 304 stainless steel, which has excellent resistance to corrosion, high mechanical strength and facilitates hygiene and cleaning conditions due to its easy cleaning. These features are ideal when transporting foodstuffs.

On the other hand, the first loading panel (5) may have different shapes depending on the type of material to be supported. For example, in case boxes are to be transported, the first loading panel (5) may have a rectangular shape.

However, the shape of the loading panels (5) can be selected from the group consisting of square shape, triangular shape, circular shape, rectangular shape, pentagonal shape, trapezoidal shape, ellipse shape, diamond shape, hexagon shape, heptagon shape, octagon shape, decagon shape, arc shape or other equivalent shapes known to a person normally skilled in the art and combinations thereof.

On the other hand, the pivot element (8) serves as a connection between the first rigid panel (2) and the first loading panel (5) when the latter is hinged. Accordingly, the pivot element (8) is selected from known pivoting hinges, pivot mechanisms with swivel, steering pivot, hydraulic pivot, or other equivalent pivoting elements known to a person skilled in the art and combinations thereof. The loading and unloading mechanism may have more than one pivot element (8) arranged along the first loading panel (5).

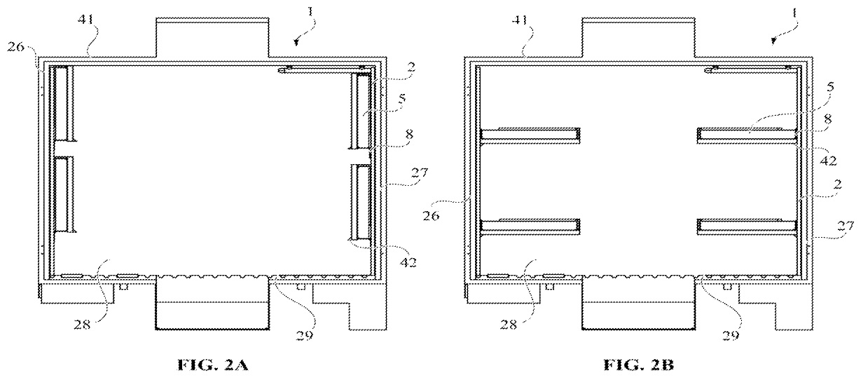

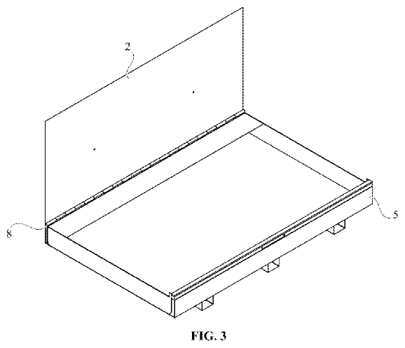

Referring to FIG. 2A, FIG. 2B and FIG. 3, a first rigid panel (2) connected to a first loading panel (5), which has a smooth top surface, is noticed. The first rigid panel (2) and the first loading panel (5) are connected by means of a pivot element (8), which is a non-rising hinge, which is located along the first loading panel (5).

Optionally, in a non-illustrated embodiment, the pivot element (8) comprises an anchor which is fixed to the first rigid panel (2), wherein said anchor is connected with a coupling element by means of a screw. The coupling element is connected with a support bar which is arranged on a lower surface of the first loading panel (5), wherein the screw allows the coupling element and consequently the support bar to rotate, whereby the first loading panel (5) is hinged with respect to a horizontal plane.

Referring to FIGS. 2A and 2B, the material loading and unloading mechanism comprises a side guide (3) located on an inner side wall (26) of the container (1); and a first rigid panel (2) connected by means of a first sliding element (6) to the side guide (3) and a first hinged loading panel (5) connected to the first rigid panel (2). The side guide (3) allows the displacement of the first rigid panel (2) along a first longitudinal direction. On the other hand, the first loading panel (5) is arranged parallel to the floor (29) of the container (1).

When the first loading panel (5) is hinged, it is ideal that the loading and unloading mechanism prevents movement beyond a defined angle of inclination; e.g., the angle of inclination may be at 90° with respect to an internal side wall of the container (1) or parallel to the floor (29). The reason for the above is because during transport the first loading panel (5) may attempt to move beyond the inclination angle, due to the presence of imperfections in the road.

For example, movement of the first loading panel (5) may be prevented by first pivot elements (8) having rotation control, such as pivot mechanisms with rotation. However, in other cases there may be first pivoting elements (8) which require locking elements, in order to control the pivoting, e.g., a stop which prevents the first loading panel (5) from continuing to lean beyond the defined lean angle.

Continuing with FIG. 2A, a first position of the first loading panel (5) is noticed. In said first position, the first loading panel (5) is perpendicular to the floor (29) and in FIG. 2B, the first loading panel (5) in a second position is parallel to the floor (29). In addition, a stop (42) is noticed, which is a protrusion located on the bottom surface of the first loading panel (5). The stop (42) located at the end where the first loading panel (5) is connected to the first rigid panel (2). On the other hand, it is noticed in the first position that the container (1) has no obstacles in its interior, so this space can be used to load large items or goods or is also useful when cleaning or maintenance work needs to be done inside the container (1).

On the other hand, the first loading panel (5) has an upper surface that comes in direct contact with the material to be loaded, unloaded, or transported. Said upper surface may be conditioned in particular ways depending on the material. For example, the upper surface may be an anti-slip surface with an average roughness (Rz) greater than 20 to improve its grip and, thus, prevent possible displacement of the material being loaded. In addition, the top surface can have a surface finish selected from high relief or low relief finishes, polymeric coatings, grids, tiles, among others.

Similarly, the first loading panel (5) may be provided with a locking mechanism (18) that prevents displacement of the goods from the upper surface.

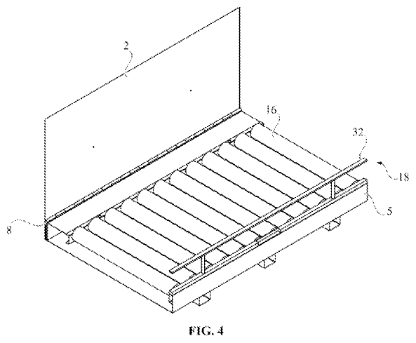

For example, referring to FIG. 4, the locking mechanism (18) may be a railing (32) arranged at least at one end of the first loading panel (5). In a particular example, the railing (32) is placed at the opposite end to the one where the first loading panel (5) and the first rigid panel (2) are connected.

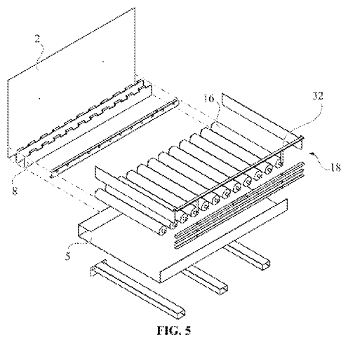

Preferably, referring to FIG. 5, the first loading panel (5) has three railings, where each railing is arranged at each end of the panel except at the end where it connects to the first rigid panel (2). This allows that in the event that the first loading panel (5) is occupied with a single material, e.g., a box, this is held fixed within the upper surface of the first loading panel (5).

On the other hand, the upper surface of the first loading panel (5) may be provided with a displacement mechanism, which facilitates moving a material (e.g., a box) across the first loading panel (5). The displacement mechanism may be selected from the group consisting of conveyor belts, screw conveyor, roller conveyor, or other equivalent displacement mechanism known to a person normally skilled in the art and combinations thereof.

Referring to FIG. 4, preferably, the first loading panel (5) on the top surface includes a locking mechanism (18) and a roller conveyor. The roller conveyor comprises first rolling elements (16) coupled to the first loading panel (5), wherein the first rolling elements (16) allow the materials to move easily along the upper surface of the first loading panel (5).

In turn, the locking mechanism may be a railing (32), said railing (32) being connected to the opposite end to the one where the first loading panel (5) is connected to the first rigid panel (2).

Preferably, the railing (32) has a retractable system, allowing it to be housed in an opening located at said opposite end, in order to allow the railing to be concealed when not in use.

On the other hand, the first loading panel (5) may have reinforcing elements. This is necessary when the stress caused by the weight of the supported material is greater than the material deformation limit of the first loading panel (5). Optionally, the reinforcing elements may be reinforcing bars arranged across the width of the first loading panel (5) on the bottom surface thereof. In a particular example, the first loading panel (5) features two reinforcing bars arranged on the bottom surface of the first loading panel (5), wherein said reinforcing bars are provided with the stop (42) to prevent the first loading panel (5) from continuing to lean beyond the defined leaning angle.

Optionally, the loading and unloading mechanism may have more than one first loading panel (5), in order to support more materials. For example, a first rigid panel (2) can be connected to more than one first loading panel (5).

Now, the loading and unloading mechanism may comprise more than one first rigid panel (1) where each first rigid panel (2) has a first loading panel (5) connected. One of the technical effects of having more than one loading panel (5) is that it allows the volume of materials in the loading and unloading operation to be increased.

Referring to FIG. 2A and FIG. 2B, in one embodiment of the invention, a first rigid panel (2) is connected to a first loading panel (5) and a second loading panel (12), wherein the first loading panel (5) and the second loading panel (12) are arranged parallel to the floor (29) of the container (1). This allows the volume of materials to be doubled in the loading and unloading operation.

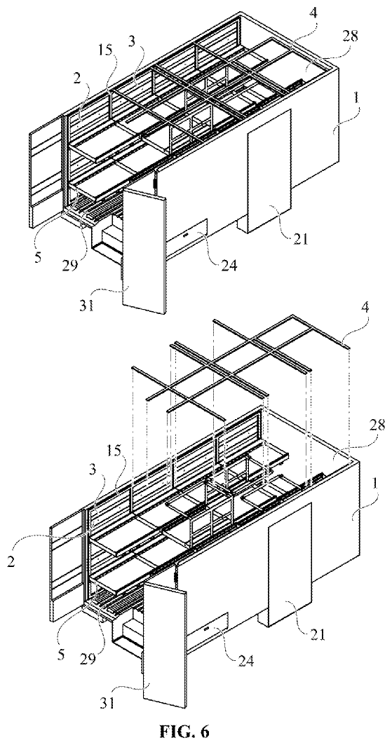

Referring to FIGS. 5 and 6, a first rigid panel (2) connected to two loading panels is noticed, particularly, the first rigid panel (2) is connected to the first loading panel (5) and to a second loading panel (12). On the other hand, the first loading panel (5) and the second loading panel (12) are hinged and connected to the first rigid panel (2) by means of a first pivot element (8) and a second pivot element (13) respectively. The first pivot element (8) and the second pivot element (13) allow the first loading panel (5) and the second loading panel (12) to be arranged in a first position perpendicular to the floor (29) of the container (1) and in a second parallel position to the floor (29) of the container (1).

When the first loading panel (5) and the second loading panel (12) are located in the second position, the operator can place the material on the upper surfaces of the first loading panel (5) and second loading panel (12), in order to move the first rigid panel (2) along the container (1) to a desired position within the container (1). One of the technical effects of having both first loading panels (5) is that it allows to move twice as much material to the desired position in a single displacement.

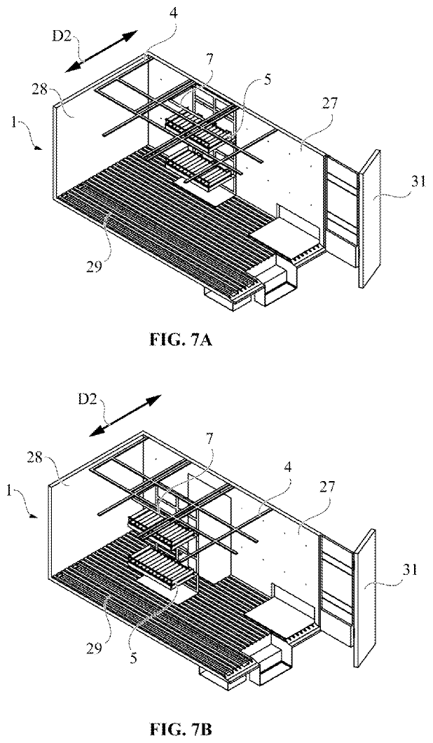

Referring to FIG. 6, and FIG. 7A in one embodiment of the invention, the guide of the material loading and unloading mechanism may be an upper guide (4) located on the ceiling (41), to said upper guide (4) the first rigid panel (2) is connected by means of a third sliding element (7).

On the other hand, referring to FIG. 6, and FIG. 7A, the material loading and unloading mechanism can have the side guide (3) located on the inner side walls (26, 27) and can further have an upper guide (4) located on the ceiling (41) of the container (1) which is connected to the first rigid panel (2) by means of the third sliding element (7). One of the technical effects of said upper guide (4) is that it allows the first rigid panel (2) to use the entire space of the container (1).

Optionally, referring to FIG. 7A, and FIG. 7B the loading and unloading mechanism comprises more than one upper guide (4) arranged on the ceiling (41) of the container (1). The upper guides (4) may be in any direction with respect to the side walls of the container (1), e.g., they may be parallel to the walls of the container (1) in case it is desired to move the first rigid panel (2) along the container (1). In another particular example, the upper guides (4) may be perpendicular to the side walls of the container in case it is desired to move the first rigid panel (2) across the container (1) width.

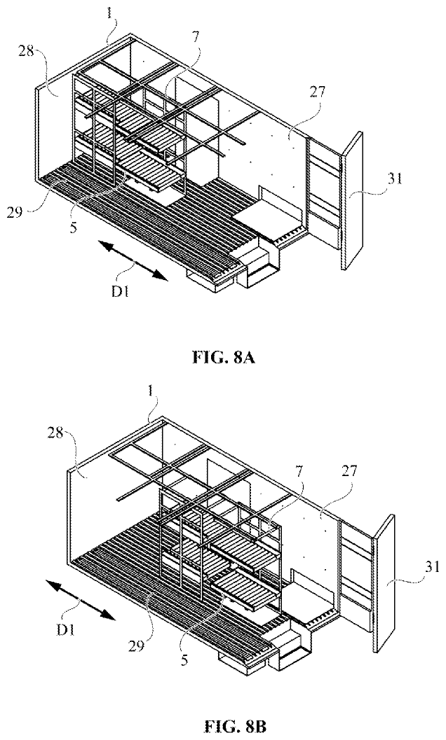

In one embodiment of the invention, referring to FIG. 7A, FIG. 7B, FIG. 8A and FIG. 8B, the side guides (3) and the upper guides (4) are arranged in such way that a first rigid panel (2) can move on both guides. In this case, the first rigid panel (2) will have the first sliding element (6) and the third sliding element (7); the third sliding element (7) being the one that connects with the upper guide (4).

In this case, the first sliding element (6) and the third sliding element (7) can be selected from the group consisting of sprockets, rollers, skids, or other equivalent sliding elements known to a person normally skilled in the art and combinations thereof optionally, the first sliding element (6) and the third sliding element (7) are skids. A skid is understood to be an element that allows sliding on a guide or surface.

On the other hand, the upper guide (4) and the side guide (3) are in charge of allowing the movement of the first rigid panel (2) inside the container (1). For example, the side guide (3) and the upper guide (4) can be selected from the group consisting of racks, rails or other elements that allow the rectilinear movement of the first rigid panel (2) and similar known to a person normally skilled in the art and combinations thereof. In a particular example, the upper guides and the side guides (4) are rails.

In one embodiment of the invention, there is a plurality of upper guides (4) which may be in different directions from each other, in order to optimize the container (1) space.

Referring to FIG. 6, the upper guides (4) may be a plurality of upper guides (4) orthogonal to each other, which are arranged on the ceiling (41) of the container (1). In this case, the upper guides (4) are rails. The foregoing allows the first rigid panels (2) to be moved lengthwise in a middle section of the container (1) and also, widthwise thereof.

According to the foregoing, the loading and unloading mechanism by means of the upper guides (4) arranged perpendicularly with respect to the side walls of the container, allows the movement of the first rigid panel (2) and consequently of the first loading panel (5) across the container (1) width, i.e., between the inner side walls (26, 27). The movement across the width allows several first rigid panels (2) with their respective first loading panel (5) to be stacked across the container (1) width. This allows the use of a space located in the central part of the container (1).

Referring to FIG. 7A and FIG. 7B, it is noticed that the first rigid panel (2) is first located in a first transverse position right at the inner side wall (27) and then, in a second transverse position that is located towards the center of the container (1). The third sliding element (7) allows the displacement of the first rigid panel (2) along a second transverse direction (D2), as the third sliding element (7) connects the first rigid panel (2) with the upper guide (4), wherein the upper guide (4) is arranged across the container (1) width.

On the other hand, the loading and unloading mechanism allows movement along the container (1) by means of the upper guides (4) which are arranged parallel to the inner side walls (26, 27). Such lengthwise movement allows several first rigid panels (2), with their respective first loading panel (5), to be stacked along the container (1). This allows the central part of the container (1) to be fully used.

Referring to FIG. 8A and FIG. 8B, the first rigid panel (2) is located first in the second transverse position in the center of the container (1) and, then, in a third longitudinal position which is located more in the vicinity of the back wall (28) of the container (1), the displacement of the first rigid panel (2) along the first longitudinal direction (D1) being allowed by the third sliding element (7) which is responsible for connecting the first rigid panel (2) and the upper guide (4) arranged along the container (1).

On the other hand, the loading and unloading mechanism of this invention may comprise more than one side guide (3), e.g., it may have a plurality of side guides (2) on an inner side wall of the container (1). In turn, the loading and unloading mechanism may comprise side guides (3) on any of the internal side walls (26, 27) of the container (1) at the same time. The foregoing is to use the entire space of the inner side walls in the container (1). In a particular example, the loading and unloading mechanism comprises a plurality of first side guides (3) and a plurality of second side guides (10) located on the inner side walls (26, 27) of the container (1) respectively.

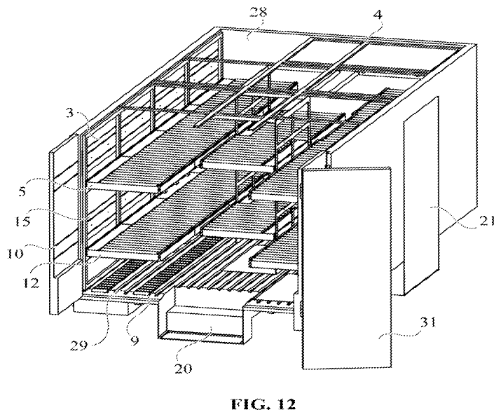

For example, referring to FIG. 12, the loading and unloading mechanism comprises two first side guides (3) and two second side guides (10) located on each inner side wall (26, 27) of the container (1) respectively, wherein the second side guides (10) are parallel to the first side guides (3). Furthermore, the first rigid panel (2) is provided with a second sliding element (11) connecting one of the second side guides (10), wherein the second sliding element (11) allows the first rigid panel (2) to move on one of the second side guides (10). Similarly, another technical effect associated with the use of more side guides (3) is the increase in the support capacity that the first loading panels (5) may have.

As mentioned above, the loading and unloading mechanism may comprise more than one first rigid panel (2) with a respective first loading panel (5). Now, in a particular example, the first rigid panels (2) may be connected to each other by means of a connecting element. The foregoing allows the exchange of the first rigid panels (2) if necessary.

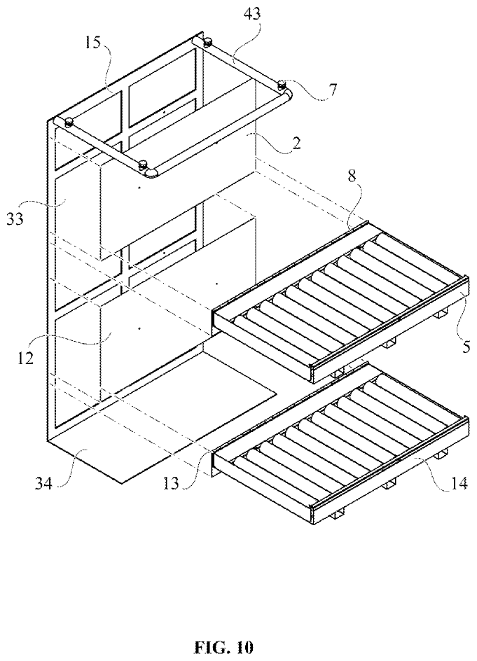

Referring to FIG. 10, the connecting element (15) is noticed prior to the assembly of the first and the second rigid panel (2, 14), in this particular example, the connecting element (15) is a C-shaped shelving structure, wherein there is an upper frame (43) in the upper part and there is a lower panel (34) in the lower part. The C-shaped shelving structure is connected to the first and the second rigid panel (2, 14) by means of fastening elements, which, in that particular case, are screws. The C-shaped shelf has openings (33), which allow the first sliding element (6) and a second sliding element (11) of the first and the second rigid panel (2, 14) to be connected to the side guides (3) arranged on the inner side walls (26, 27) of the container (1). On the other hand, the upper frame (43) has third sliding elements (7) that connect with the upper guides (4).

On the other hand, the connecting assembly (15) can be an inverted L-shaped shelving structure, said structure in its upper part has an upper frame (43) where the third slide (7) is arranged. The foregoing allows to avoid interference with elements arranged on the floor (29) of the container (1).

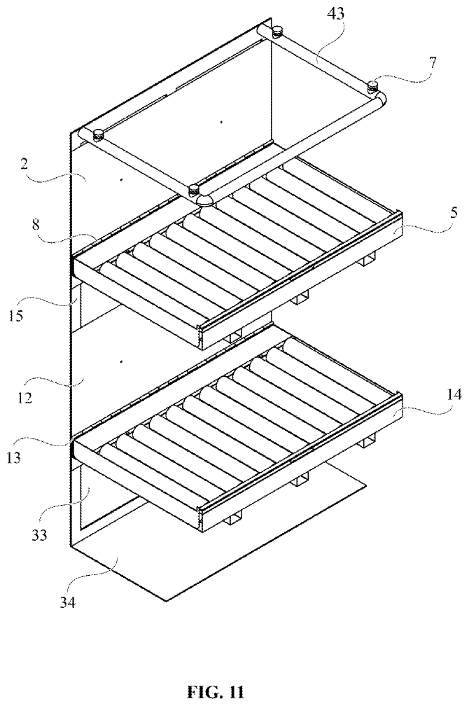

Referring to FIG. 11, in one embodiment of the invention, a first rigid panel (2) and a second rigid panel (14) are connected to two loading panels. Particularly, the first rigid panel (2) is connected to the first loading panel (5) and the second rigid panel (14) is connected to a second loading panel (12), said second rigid panel (14) is connected to second side guides (10) by means of the second sliding element (11). Further, the first rigid panel (2) is connected to the second rigid panel (14) by means of the connecting element (15), wherein, the first loading panel (5) and the second loading panel (12) are hinged and are connected to the first rigid panel (2) by means of a first pivot element (8) and a second pivot element (13) respectively. The first pivot element (8) and the second pivot element (13) allow the first loading panel (5) and the second panel (12) to be arranged in a first position perpendicular to the floor (29) of the container (1) and in a second parallel position to the floor (29) of the container (1).

Referring further to FIG. 11, the first loading panel (5) and the second loading panel (12) may be hinged and connected to the first rigid panel (2) by a first pivot element (8) and a second pivot element (13) respectively; wherein the first pivot element (8) and the second pivot element (13) allow the first cargo panel (5) and the second cargo panel (12) to be arranged in a first position perpendicular to the floor (29) of the container (1) and in a second parallel position to the floor (29) of the container (1).

Preferably, the heights with respect to the floor (29) of the first loading panel (5) and the second loading panel (12) are given by the average height of a person's knee, shoulder, and iliac spine. For example, the height of the second panel (14) with respect to the floor (29) may be approximately between 450 mm and 600 mm, bearing in mind that the average knee height of a person is 508 mm. In another example, the height of the first loading panel (5) with respect to the floor (29) may be approximately between 900 mm and 1,600 mm, having finds that the average height of a person's shoulder is 1,300 mm and the average height of a person's iliac spine is 936 mm. These heights of the first and second rigid panels (5, 14) prevent musculoskeletal disorders such as low back pain.

On the other hand, the loading and unloading mechanism can be provided with a displacement mechanism located on the floor (29) of the container (1), which facilitates the movement of a material (e.g., a box) through the container (1). The displacement mechanism may be selected from groups consisting of conveyor belts, screw conveyors, roller conveyors, or other equivalent displacement mechanism known to a person normally skilled in the art, and combinations thereof.

For example, referring to FIGS. 11 and 12, the floor (29) of the container (1) includes a roller conveyor. The roller conveyor comprises second rolling elements (9) arranged on the floor (29) of the container (1) formed a line, wherein the second rolling elements (16) allow the materials to move easily across the floor (29) of the container (1).

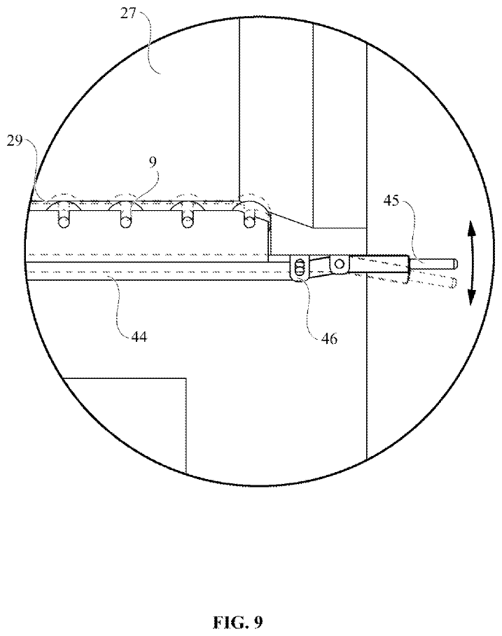

Optionally, referring to FIG. 9, and FIG. 12, the second rolling elements (9) are operatively connected to a vertical displacement mechanism arranged on the floor (29) of the container (1) and connected to the second rolling elements (9). Said vertical displacement mechanism makes it possible to hide the second rolling elements (9) within the floor (29) of the container (1).

The vertical displacement mechanism can be selected from the group consisting of hydraulic mechanisms, pneumatic mechanisms, mechanical mechanisms, pressure actuators or other mechanisms allowing vertical displacement of the rolling elements (9) known to a person normally skilled in the art and combinations thereof.

When the second rolling elements (9) protrude from the floor (29), they are referred to as being in a transport position. For example, the second rolling elements (9) may protrude between 0.5 mm to 30 mm relative to the floor (29) of the container (1), in a particular example 10 mm.

Optionally, there can be more than one line of second rolling elements (9). This multiple line configuration allows the movement of wider boxes, e.g., a single line of second rolling elements (9) with a length of 150 mm can move boxes of a width between 50 mm to 220 mm. Similarly, with two lines of second rolling elements (9) spaced 224 mm apart, boxes of a width between 260 mm and 540 mm can be moved.

On the other hand, the line of second rolling elements (9) may have a length range of between 0.5 m and 10 m. In one embodiment of the invention, the second rolling elements (9) are connected to the vertical displacement mechanism, which is a pressure actuator that exerts a pressure to the second rolling elements (9), which allows the second rolling elements (9) to protrude from the floor (29).

In this case, the second rolling elements (9) are lowered level with the surface of the floor (29), once a weight is placed on them exceeding a permissible weight, this permissible weight being equal to the pressure exerted by the pressure actuator on the second rolling elements (9). The permissible weight can be defined between 20 kg to 40 kg, preferably 27 kg.

The foregoing ensures that the boxes slide smoothly over the second rolling elements (9) and guarantees that when an operator has to walk over the rollers, they do not represent a risk of falling. This is because the second rolling elements (9) descend when the operator rests on them, since the weight is greater than the pressure exerted by the pressure actuators on the second rolling elements (9).

On the other hand, referring to FIG. 9, the vertical displacement mechanism may comprise a bar (44) which is arranged along the container (1) and below the floor (29) of said container (1). In turn, the bar (44) has one end connected to a lever (45) and has a pivot element at its other end. The lever (44) is coupled to a coupling element (46) which receives it. While the lever is coupled to the coupling element (46), said coupling element (46) holds the bar (44) at a distance from the floor (29), wherein at said distance the second rolling elements (9) are protruding from the floor (29) of the container (1).

Once the lever (45) is disengaged from the coupling element, the bar pivots due to the pivot element located at its other end. That pivoting movement causes the distance of the bar with respect to the floor (29) of the container (1) to increase, and that also allows the second rolling elements (9) to hide or protrude from the floor (29) of the container (1).

On the other hand, referring to FIGS. 6 and 12 the loading and unloading mechanism may comprise more than one first rigid panel (2), wherein the first rigid panels (2) may be arranged in series, either next to each other, or each panel spaced apart from each other by a given distance. In turn, said first rigid panels (2) may comprise more than one first loading panel (5), wherein each first loading panel (5) may be spaced in such way that materials can be placed thereon, e.g., boxes, packaged food, containers, pallets, among others.

Therefore, the loading and unloading mechanism may have first loading panels (5) arranged at a height that means for the operator a considerable effort when loading the material up to the upper surface of the first loading panel (5). Consequently, the mechanism needs an element for lifting materials inside the container (1).

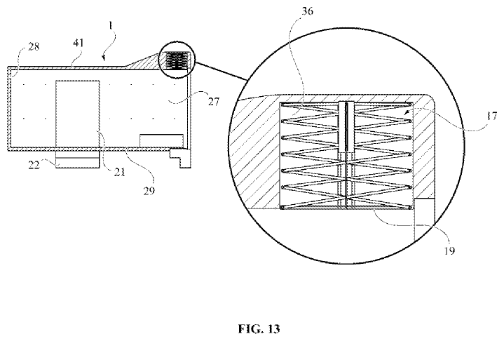

Referring now to FIG. 13, the loading and unloading mechanism may further comprise a platform (19) connected to the container (1) by a lifting mechanism (17), wherein the lifting mechanism (17) allows the platform (19) to be moved vertically.

The lifting mechanism (17) may be selected from the group consisting of pulleys, movable pulleys, compound pulleys, hydraulic pistons, pneumatic pistons, gear mechanisms, or other equivalent lifting mechanism known to a person normally skilled in the art and combinations thereof.

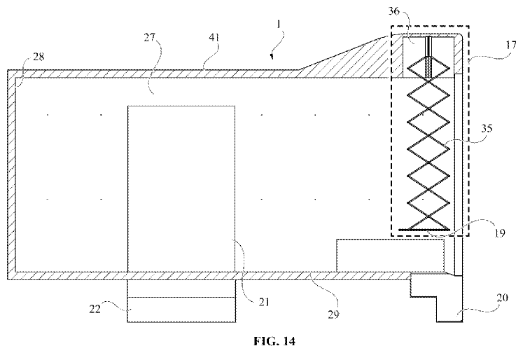

Referring to FIGS. 13 and 14, preferably, the container (1) has a housing (36) on the ceiling (41) of the container (1), where the lifting mechanism (17) is located. The lifting mechanism (17) comprises foldable unloading bars (35), which are connected to the platform (19). In addition, the housing (36) on the ceiling (41) allows to hide the folding unloading bars (35) once they are folded, while the lifting mechanism is not in use.

The foldable unloading bars (35) are composed of interlocking bars joined at their ends by a pivot element, said pivot element allowing the interlocking bars to move in a tilting motion. The foldable unloading bars (35) are designed so that with the weight of the platform (19), the foldable unloading bars (35) do not move while keeping the platform (19) static, i.e., the unloading bars remain folded. However, when it is desired to move the platform (19), the operator must exert force on the platform (19) in one direction in order to unfold the foldable unloading bars (35) to the desired height. The foldable unloading bars (35) facilitate the vertical displacement of materials on the platform (19), preventing the user from having a bad posture when lifting a weight of a material to be loaded or unloaded.

The container (1) may further comprise an access ladder (20) located at the main entrance (30) to facilitate operator access to the container (1) thereby decreasing the physical effort to enter and exit the container (1) by the operator. The access ladders (20) may be connected to the floor (29) of the container (1) or may be embedded to the floor (29) of the container (1).

On the other hand, the container (1) may include several access ladders (20) to the main entrance (30), the addition of different access ladders to the main entrance (30) allowing several operators to enter the container (1) at the same time.

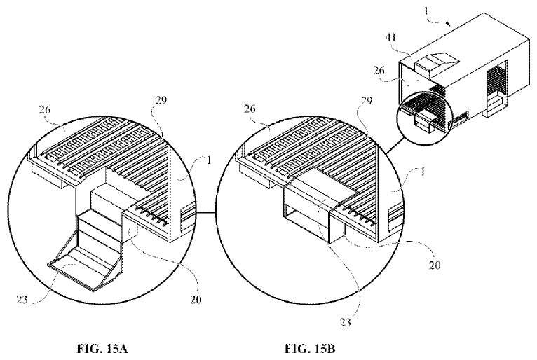

Referring to FIG. 14, FIG. 15A and FIG. 15B, the loading and unloading mechanism further comprises an access ladder (20) that is connected and embedded to the floor (29) of the container (1). The access ladder (20) is located in the area of the floor (29) which is located at the main entrance (30) of the container (1). On the other hand, the container (1) at the main entrance (30) has two hinged doors.

Now, if the access ladder (20) is embedded, this means that part of the floor (29) of the container (1) is wasted due to the hole left by the embedded access ladder (20). Therefore, the loading and unloading mechanism can be provided with a lid that covers the hole left by the access ladder (20) embedded to the floor (29) of the container (1). This lid may be connected to the floor (29) of the container (1), either by a pivoting element (e.g., hinge), or by a retractable system. In one example, the lid is connected to a retractable system consisting of rails located one on each side of the lid, which allows the lid to move. The movement generated by the retractable system allows the lid to be housed in an opening within the floor of the container (1) to be hidden.

On the other hand, the lid for covering the access ladder (20) embedded to the floor (29) of the container (1) can be housed in the hole and completely removed when the access ladder (20) is to be used. In this case, the lid and the hole have a fit that allows the lid to be pushed into the hole by hand. One of the technical effects of covering the hole formed by the access ladder (20) embedded to the floor (29), is that it allows to optimize the covered space to place materials in that area.

In one embodiment of the invention, the cover is an additional extension step (23), which is connected to the access ladder (20). The connecting mechanism between the additional extension step (23) and the access ladder (20) allows the additional extension step (23) to rotate on itself. The connecting mechanism may be a pivot shaft, hinge, or any other mechanism known to a person normally skilled in the art that allows the additional extension step (23) to rotate in on itself.

Referring to FIGS. 15B and 15A, the access ladder (20) has the additional extension step (23) connected by means of a pivot element to the last step of the access ladder (20). The additional extension step (23) can rotate on itself and be in two positions, in a first position, as seen in FIG. 15A, the additional extension step (23) is deployed, in this position the additional extension step (23) functions as a further step of the access ladder (20). Further, in FIG. 15B the additional extension step is in a second position, wherein the additional extension step (23) is folded, in this position the additional extension step (23) covers the hole formed by the access ladder (20), when the access ladder (20) is not in use.

On the other hand, the container (1) can have more entrances than just the main entrance (30), which allows the operator to enter different sections of the container (1). Additionally, the presence of several entrances is very useful in case the container (1) is very long or if the main entrance (30) is blocked either by material or by some external entity. In a particular example, the container (1) has a side entrance (21) located on a side wall of the container (1). The side entrance (21) may have an isolation system selected from the group consisting of sliding doors, hinged doors or other types of container entrances known to a person normally skilled in the art.

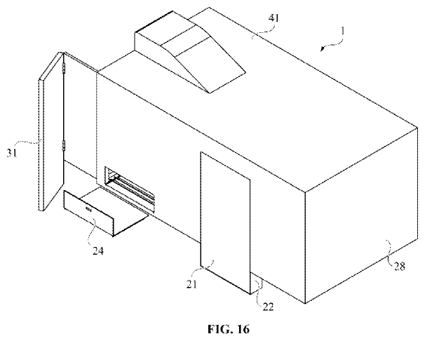

Referring to FIG. 14, FIG. 16A and FIG. 16B, preferably, the container (1) has a side entrance (21) located on a side wall of the container (1). For example, the side entrance (21) may have a sliding door that allows for better utilization of the space of the container (1). Preferably, said side entrance (21) is located in close proximity to the back wall (28) of the container (1) thereby allowing the operator to pick up materials located at the end of the container (1) more quickly.

Preferably, at each additional entrance provided in the container (1) an access ladder can be added. This is done with the objective of facilitating the operator's access to the container (1) thereby decreasing the physical effort of the operator to enter and exit the container (1).

Referring to FIG. 14, the container (1) includes a second access ladder (22) connected to the side entrance (21). Like the access ladder (20), the second access ladder (22) decreases physical effort to enter and exit the container (1).

On the other hand, referring to FIG. 16, in case access to the material housed inside the container (1) is desired and it is not necessary for the operator to enter the container (1), the container (1) may have a compartment (24). Said compartment (24) is arranged in a side wall of the container (1). Once the compartment (24) is open, it will leave an opening in the side wall of the container (1) large enough for an operator to remove materials located inside the container (1) that are adjacent to the opening created by the compartment.

For example, referring to FIG. 16, the container (1) has a compartment (24) located in a side wall of the container (1) in the vicinity of the floor (29) of the container (1), said compartment (24) having a displacing mechanism that allows the compartment (24) to be moved to open and close the compartment (24), wherein, once the compartment (24) is open it forms an opening in the side wall, large enough for the operator to remove material adjacent to the opening. The position close to the floor of the container (1) and the compartment (24) is to facilitate access to the materials inside the container (1). The displacement mechanism may comprise slots located on the floor (29) of the container (1) and sliding elements arranged on the bottom surface of the housing (24), wherein the sliding elements slide over the slots to allow movement of the housing (24).

In another aspect of the invention, the container (1) may be provided with a leveling mechanism (25) connected between the container (1) and to the vehicle chassis, wherein the leveling mechanism (25) allows changing the inclination of the floor (29) of the container (1) with respect to a beam of the vehicle chassis.

The leveling mechanism (25) can have two or more functions. A first function is to reduce the impact on the unloading operation in scenarios with steep slopes, since it allows to control the inclination of the container (1). According to NTC4143 the maximum slope for safe operation is 12 degrees, therefore, the leveling mechanism (25) allows an angle of inclination (α°) no greater than 10°. In a particular example, the angle of inclination (α°) of the container (1) is 4°. A second function is that in cases where there is a leveled surface (distribution centers), the inclination offered by the leveling mechanism (25) allows loading by gravity on the loading panels (5), the inclination of the container (1) allows the materials to move on the upper surface of the first panels (5) or on the floor (29).

The leveling mechanism (25) can be selected from the group consisting of pulleys, movable pulleys, compound pulleys, gear mechanism, hydraulic pistons, pneumatic pistons, a turntable, a threaded spindle mechanism, other mechanisms for surface leaning by a person skilled in the art, or combinations thereof.

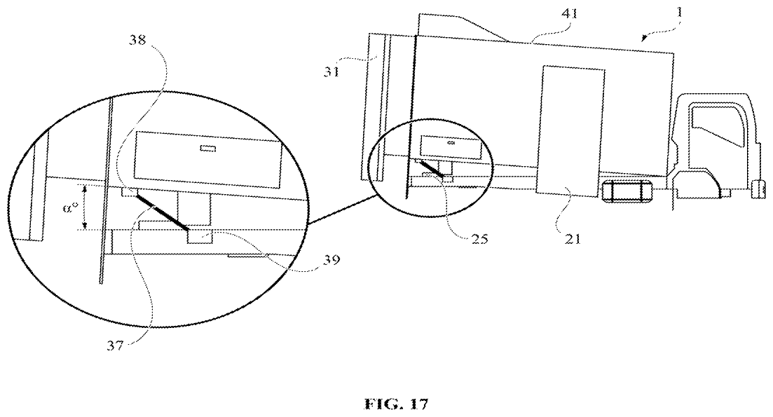

Referring to FIG. 17, the container (1) is inclined at an angle of inclination (α°) by means of the leveling mechanism (25), wherein the leveling mechanism (25) is a hydraulic piston (37) comprising a first anchoring means (38) arranged on the chassis of the vehicle that is supporting the container (1), said first anchoring means (38) being connected with the hydraulic piston (37) at one end. On the other hand, the hydraulic piston (37) is connected at the opposite end with a second anchoring means (39) coupled to the floor (29) of the container (1).

Now, once the container (1) is inclined by means of the leveling mechanism (25) and to ensure an appropriate height of entry to the container (1), the access ladder (20) may have the additional extension step (23) to compensate for the increase in height of the container (1). The above to facilitate the operator's entry into the container (1) in case of large inclines.

### EXAMPLES

### Example 1

A container with a loading mechanism was designed and built with the following features:

Container (1):

Material: Polystyrene

Length: 4,452.40 mm

Width: 2,402.40 mm

Height: 2,052.40 mm

Isolation System (31):

Types: Hinged doors

Quantity: 3

Material: Polystyrene

Width: 757.40 mm

Height: 2,821.87 mm

Housing (36):

Material: Polystyrene

Length: 1600 mm

Width: 775.40

Side Guides (3) and Second Side Guides (10):

Type: Rail

Material: 1060 alloy (Aluminum)

Upper Guides (4):

Type: Rail

Material: 1060 alloy (Aluminum)

First Rigid Panel (2) and Second Rigid Panel (14):

Material: 304 stainless steel AISI

Width: 1,050 mm

Height: 561 mm

First Loading Panel (5) and Second Loading Panel (12):

Material: 304 stainless steel AISI

Length: 676 mm

Width: 1,050 mm

Height: 101 mm

Pivot Element (8) and Second Pivot Element (13):

Type: Hinge

Material: Stainless steel AISI 304

First Sliding Element (6), Third Sliding Element (7) and Second Sliding Element (11):

Type: skid

First Rolling Elements (16) and Second Rolling Elements (9):

Type: Light rollers L series of 60 mm diameter.

Material: 1023 carbon steel plate (SS)

Connecting Element (15)

Type: C-shelf

Material: 1060 alloy (Aluminum)

Lifting Mechanism (17):

Type: Foldable bars (35)

Material: 1060 alloy (Aluminum)

Plataforma (19):

Material: 304 stainless steel AISI

Length: 735.40 mm

Width: 497.60 mm

Thickness: 15 mm

Access Stairway (20) and Second Access Stairway (22):

Material: Polystyrene

Side Entry (21):

Type: sliding door

Material: Polystyrene

Width: 743.40 mm

Height: 2,416.50 mm

Wall thickness: 76.20 mm

Additional Step (23)

Material: Polystyrene

Compartment (24):

Length: 1,048 mm

Width: 766.20 mm

Leveling Mechanism (25)

Type: hydraulic piston

### Example 2

For this example, two reinforcing bars were added to the mechanism of example 1 on the bottom surface of the first and second loading panels (5, 12). With the reinforcing bars, the first and second loading panels (5, 12) did not suffer deformations below 1,200 N of weight which is equivalent to almost twice the maximum load that the first and second loading panels (5, 12) must support, if they support for example a 25 kg box in a loading and unloading operation.

With the devices of both examples, the time in the loading and unloading operations of materials is improved, and muscular diseases, which occur in this type of operations, due to the loading or pushing of heavy materials, are prevented. Additionally, the design of Example 2 more than doubled the maximum load of the first and second loading panels (5).

It shall be understood that this invention is not limited to the embodiments described and illustrated, for as will be evident to a person skilled in the art, there are possible variations and modifications, which do not depart from the invention spirit, defined by the following claims.

1. A material loading and unloading mechanism for a container (1), comprising:
a guide located inside the container (1);
a first rigid panel (2) connected by means of a first sliding element (6) to the guide, wherein the guide allows displacement of the first rigid panel (2) along a direction; and
a first loading panel (5) connected to the first rigid panel (2), wherein said first loading panel (5) is arranged parallel to a floor (29) of the container (1).

2. The mechanism according to claim 1, wherein the container (1) is arranged on the chassis of a vehicle selected from the group including two-axle trucks, three-axle trucks, vans, pickup trucks, tractor-trailers, automobiles, boats, motorboats, ships, helicopters, airplanes, motorcars, motor freighters and three-wheeled vehicles.

3. The mechanism according to claim 1, wherein the first loading panel (5) is hinged and is connected to the first rigid panel (2) by means of a first pivot element (8); wherein the first pivot element (8) allows the first loading panel (5) to be arranged in a first position perpendicular to the floor (29) of the container (1) and in a second parallel position to the floor (29) of the container (1).

4. The mechanism according to claim 1, wherein the guide is a side guide (3) located on an inner side wall (26, 27) of the container (1).

5. The mechanism according to claim 4, further comprising an upper guide (4) located on a ceiling (41) of the container (1) which is connected to the first rigid panel (2) by means of a third sliding element (7).

6. The mechanism according to claim 5, wherein the side guide (3) and the upper guide (4) are rails.

7. The mechanism according to claim 5, characterized in that it includes two upper guides (4) orthogonal to each other which are arranged on the ceiling (41) of the container (1).

8. The mechanism according to claim 5, wherein the first sliding element (6) and the third sliding element (7) are skids.

9. The mechanism according to claim 1, wherein the first loading panel (5) has a top surface including first rolling elements (16) coupled to the guide, wherein the first rolling elements (16) allow the first loading panel (5) to be displaced on the guide.

10. The mechanism according to claim 1, further comprising second rolling elements (9) arranged on the floor (29) of the container (1).

11. The mechanism according to claim 10, further comprising a vertical displacement mechanism arranged on the floor (29) of the container (1) and connected to the second rolling elements (9), wherein the vertical displacement mechanism allows the second rolling elements (9) to be concealed within the floor (29) of the container (1).

12. The mechanism according to claim 1, further comprising a plurality of guides, comprising a plurality of side guides (3) and a plurality of second side guides (10) located on inner side walls of the container (1), wherein the second side guides (10) are parallel to the first side guides (3).

13. The mechanism according to claim 12, wherein the first rigid panel (2) has a second sliding element (11) connected to one of the second side guides (10), wherein the second sliding element (11) allows the first rigid panel (2) to move on a second side guide (10).

14. The mechanism according to claim 13, wherein the first rigid panel (2) is connected to a second loading panel (12) which is arranged parallel to the floor of the container (1).

15. The mechanism according to claim 14, wherein the first loading panel (5) is connected to the first rigid panel (2) by a first pivot element (8) and the second loading panel (12) is connected to the first rigid panel (2) by a second pivot element (13); wherein the first pivot element (8) and the second pivot element (13) allow the first loading panel (5) and the second loading panel (12) to be arranged in a first position perpendicular to the floor (29) of the container (1) and in a second parallel position to the floor (29) of the container (1).

16. The mechanism according to claim 13, further comprising:
a second rigid panel (14) connected to the second side guides (10) by means of a second sliding element (11) and connected to the first rigid panel (2) by means of a connecting element (15); and
a second loading panel (12) connected to the second rigid panel (14) which is arranged parallel to the floor (29) of the container (1).

17. The mechanism according to claim 16, wherein the first loading panel (5) is connected to the first rigid panel (2) by a first pivot element (8) and the second loading panel (12) is connected to the first rigid panel (2) by a second pivot element (13); wherein the first pivot element (8) and the second pivot element (13) allow the first loading panel (5) and the second loading panel (12) to be arranged in a first position perpendicular to the floor (29) of the container (1) and in a second parallel position to the floor (29) of the container (1).

18. The mechanism according to claim 1, further comprising a platform (19) connected to the container (1) by a lifting mechanism (17), wherein the lifting mechanism (17) allows the platform (19) to be vertically moved.

19. The mechanism according to claim 1, wherein the first loading panel (5) has a locking mechanism (18) preventing horizontal displacement of a material arranged on said first loading panel (5).

20. The mechanism according to claim 1, wherein the container (1) includes an access ladder (20).

21. The mechanism according to claim 20, wherein the access ladder (20) is connected to the floor (29) of the container (1) and has an additional extension step (23) connected by means of a pivot element to the last step of the access ladder (20).

22. The mechanism according to claim 1, wherein the container (1) has a leveling mechanism connected between the container (1) and the vehicle chassis, wherein the leveling mechanism allows changing the inclination of the floor (29) of the container (1) with respect to a beam of the vehicle chassis.

23. The mechanism according to claim 1, wherein the container (1) has a side entrance (21) located in a side wall of the container (1).

24. The mechanism according to claim 23, wherein the container (1) includes a second ladder (22) connected to the side entrance (21).
